(19) United States
(12) Patent Application Publication
(10) Pub. No.: US 2004/0265195 A1
(43) Pub. Date: Dec. 30, 2004

(54) Gas injector for use in semiconductor fabricating apparatus

(75) Inventor: Sang Gon Lee, Songnam-shi (KR)

Correspondence Address: Marger Johnson & McCollom, P.C., 1030 SW Morrison Street, Portland, OR, 97205, US

(73) Assignee: Jusung Engineering Co., Ltd., Kwangju-gun (KR)

(21) Appl. No.: 10/877,298

(22) Filed: Jun. 24, 2004

(30) Foreign Application Priority Data
Jun. 25, 2003 (KR) 2003-41412

(51) Int. Cl. B01F 15/00; B01D 9/00

(52) U.S. Cl. 422/245.1

(57) ABSTRACT

A gas injector for supplying gas into a reaction chamber, in which a substrate is placed, including a main supply tube extending through the reaction chamber such that an outlet end of the main supply tube is positioned in the interior of the reaction chamber, branch tubes branched from the outlet end of the main supply tube, and injector port members connected to respective outlet ends of the branch tubes. Gas from an external gas supply source is supplied into the main supply tube. Each injector port member has a plurality of nozzle holes. Since gas is distributed through the branch tubes, and is then injected through the nozzle holes provided at each injector port member, it is possible to achieve uniform gas injection, and thus, to achieve an improvement in process uniformity.

The present invention claims the benefit of Korean Patent Application No. 2003-41412 filed in Korea on Jun. 25, 2003, which is hereby incorporated by reference.

### BACKGROUND OF THE INVENTION

1. Field of the Invention

The present invention relates to a gas injector, and, more particularly, to a gas injector capable of achieving uniform gas injection over an increased area.

2. Description of the Related Art

In pace with development of semiconductor devices with an increased degree of integration, development of new thin film deposition techniques has recently been required. A representative one of such techniques is an atomic layer deposition process.

Atomic layer deposition is a technique of depositing a thin film by alternately supplying materials of constituent elements, to constitute the thin film, onto a substrate, thereby alternately depositing atomic layers thereof, as compared to general chemical vapor deposition (CVD) processes, in which materials of constituent elements are simultaneously supplied onto a substrate, for deposition of a thin film. For such an atomic layer deposition process, accordingly, it is necessary to use a gas injection system, which is different from gas injection systems used in general CVD processes. A representative gas injection system used in the atomic layer deposition process is a propeller type gas injector. Although such a propeller type gas injector is mainly used in atomic layer deposition processes, it may also be applied to other conventional thin film deposition processes.

FIGS. 1A and 1B illustrate a conventional propeller type gas injector.

Referring to FIGS. 1A and 1B, gas from an external gas supply source is supplied into a main supply tube 10, which extends vertically. The gas supplied into the main supply tube 10 is then injected into a space defined over a wafer 30 through nozzle holes 25 provided at injector port members 20 radially horizontally branched from the main supply tube 10. At this time, the amount of gas injected at a region A is less than the amount of gas injected at a region B due to the structure of the injector. For this reason, a degradation in process uniformity occurs.

That is, the conventional propeller type gas injector has a problem in that there is a degradation in process uniformity because the amount of injected gas is gradually reduced as the injector port members 20 extend radially outward.

### SUMMARY OF THE INVENTION

Therefore, it is an object of the invention to provide a gas injector capable of achieving uniform gas injection over an increased area, thereby achieving an improvement in process uniformity.

In accordance with the present invention, this object is accomplished by providing a gas injector for supplying gas into a reaction chamber, in which a substrate is placed, comprising: a main supply tube extending through the reaction chamber such that an outlet end of the main supply tube is positioned in the interior of the reaction chamber, the main supply tube receiving gas supplied from an external gas supply source; a plurality of branch tubes branched from the outlet end of the main supply tube; and at least one injector port member connected to respective outlet ends of the branch tubes, the injector port member having a plurality of nozzle holes.

The at least one injector port member may comprise a single injector port member connected to the outlet ends of the branch tubes. Alternatively, the at least one injector port member may comprise a plurality of injector port members respectively connected to the outlet ends of the branch tubes. In the former case, each outlet end of each branch tube may be connected to an associated one of the injector port members between the nozzle holes arranged adjacent to the outlet end of the branch tube such that the outlet end of the branch tube is spaced apart from the nozzle holes by the same distance. In the latter case, the branch tubes may have the same length, and the branch tubes may be radially branched from the outlet end of the main supply tube.

The gas injector may further comprise extension branch tubes extending from respective outlet ends of the branch tubes, each extension branch tube branching a gas path defined by an associated one of the branch tubes into at least two paths. In this case, each injector port member may be connected to outlet ends of an associated one of the extension branch tubes. In this case, each outlet end of each extension branch tube may be connected to an associated one of the injector port members between the nozzle holes arranged adjacent to the outlet end of the extension branch tube such that the outlet end of the extension branch tube is spaced apart from the nozzle holes by the same distance. The gas injector may further comprise re-extension branch tubes extending from respective outlet ends of each extension branch tube. Each re-extension branch tube may branch a gas path defined by the extension branch tube into at least two paths. In this case, the injector port member, which is associated with the extension branch tube, may be connected to outlet ends of the re-extension branch tubes.

Each injector port member may have a bar shape or a plate shape. The branch tubes have no nozzle holes, so that they simply serve as a gas path.

The injector port members may be arranged in parallel to the substrate.

The main supply tube may be rotatable about an axis thereof.

### BRIEF DESCRIPTION OF THE DRAWINGS

The above objects, and other features and advantages of the present invention will become more apparent after reading the following detailed description when taken in conjunction with the drawings, in which:

FIGS. 1A and 1B are schematic views illustrating a conventional propeller type gas injector; and

FIGS. 2 to 5 are schematic views respectively illustrating gas injectors according to various embodiments of the present invention.

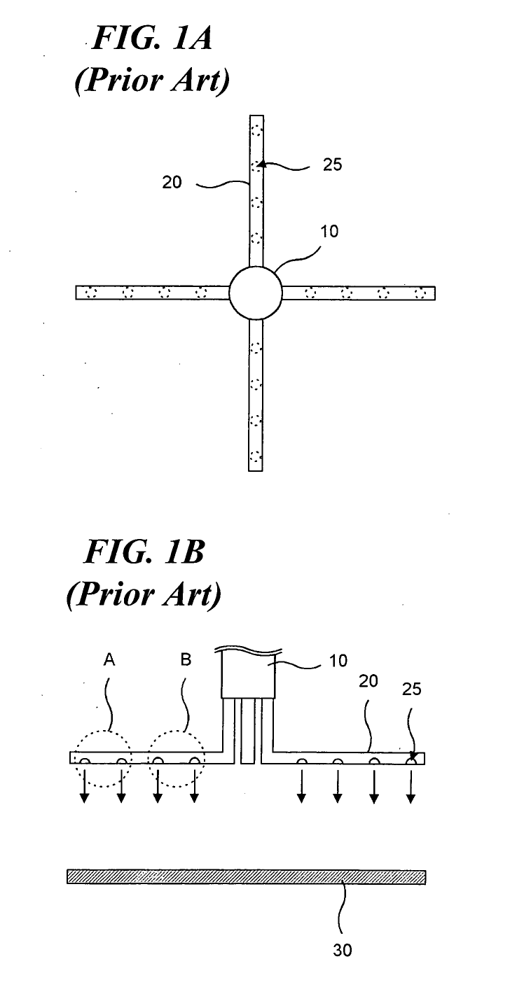

### DETAILED DESCRIPTION OF THE PREFERRED EMBODIMENTS

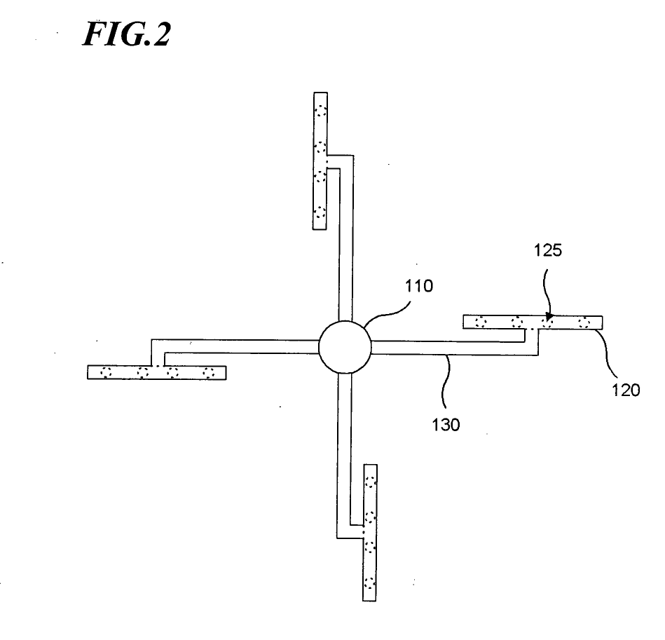

FIG. 2 illustrates a gas injector according to an embodiment of the present invention. The gas injector shown in FIG. 2 is adapted to supply gas into a reaction chamber (not shown), in which a substrate is placed. A main supply tube 110 extends through the reaction chamber such that an outlet end of the main supply tube 110 is positioned in the interior of the reaction chamber.

A plurality of branch tubes 130 are radially outwardly branched from the outlet end of the main supply tube 110, so as to distribute gas supplied from an external gas supply source into the main supply tube 110 along paths respectively defined by the branch tubes 130. Injector port members 120 are provided at respective outlet ends of the branch tubes 130 such that the injector port members 120 communicate with respective branch tubes 130. The gas distributed into the branch tubes 130 is injected into a space defined over the substrate through a plurality of nozzle holes 125 formed at the branch tubes 130.

The nozzle holes 125 provided at each branch tube 130 are uniformly spaced apart from one another along the branch tube 130 to uniformly inject gas. In order to uniformly inject gas over the substrate, it is desirable that the branch tubes 130 have the same length. It is also desirable that the branch tubes 130 are branched from the outlet end of the main supply tube 110 to extend radially outward while being uniformly circumferentially spaced apart from one another.

Each injector port member 120 may have a suitable shape, for example, a plate shape or a bar shape. Preferably, the injector port members 120 extend in parallel to the substrate in order to achieve uniform injection of gas. The branch tubes 130 have no nozzle hole, so that they simply serve as a gas path.

In accordance with a more preferred embodiment of the present invention, each injector port member 120 may be connected to the associated branch tube 130 via an extension branch tube 140. The extension branch tube 140 extends from the outlet end of the associated branch tube 130 to branch the gas path of the branch tube 130 into two paths. The extension branch tube 140 is connected, at opposite ends thereof, to the associated injector port member 120. In this case, the gas supplied into the main supply tube 110 is primarily distributed in the four directions through the branch tubes 130, and is secondarily distributed into two paths through each extension branch tube 140. Accordingly, respective amounts of gas distributed to the nozzle holes 125 are approximately equal, so that it is possible to obtain further improved process uniformity, as compared to the case of FIG. 2. In this case, it is also desirable that each end of each extension branch tube 140 is connected to the associated injector port member 120 between the nozzle holes 125 arranged adjacent to the end of the extension branch tube 140 such that the end of the extension branch tube 140 is spaced apart from the nozzle holes 125 by the same distance. Similarly to the main supply tube 110, the extension branch tubes 140 have no nozzle hole, so that they simply serve as a gas path.

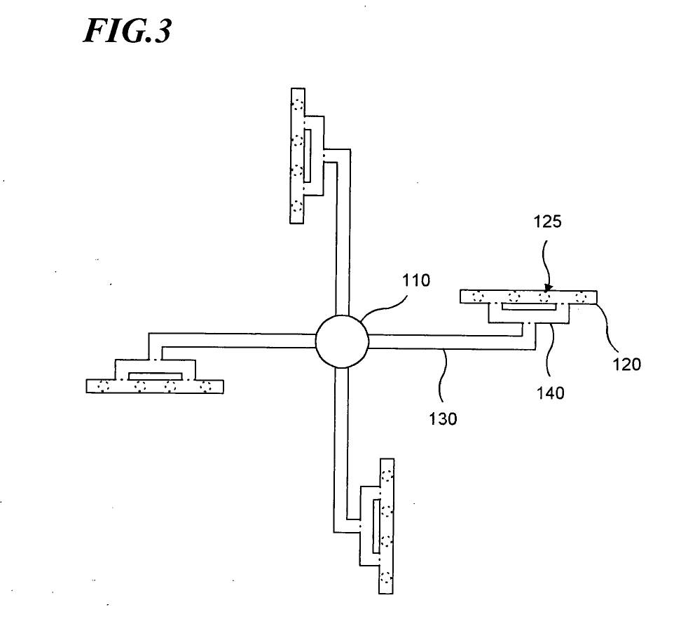

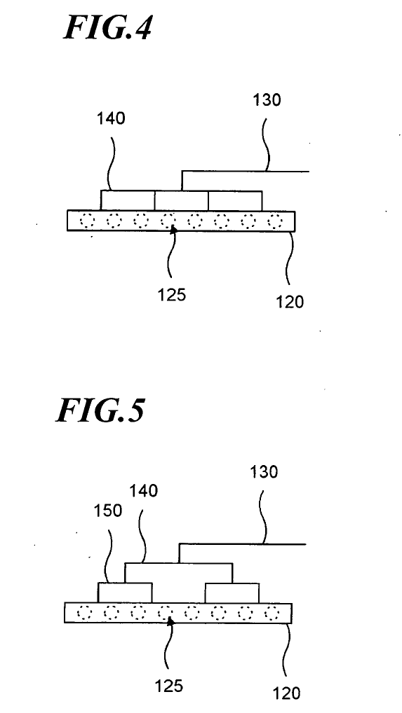

Although each extension branch tube 140 has a structure providing two branched paths in the above-described case, it is not limited thereto. Each extension branch tube 140 may have a structure providing an appropriate number of branched paths, taking into consideration the arrangement and number of the nozzle holes 125. FIG. 4 illustrates an extension branch tube structure providing four branched paths. In the case of an extension branch tube structure providing an excessive number of branched paths, however, the effect expected by the provision of branched paths is rather inferior to the case of FIG. 3. That is, in the case of FIG. 4, the paths respectively extending from each branch tube 130 to the associated nozzle holes 125 have different lengths, so that respective amounts of gas supplied to the nozzle holes 125 may be non-uniform, as compared to the case of FIG. 3. Of course, where the number of nozzle holes 125 is large, and the pressure of the supplied gas is sufficiently high, such a structure, which provides an increased number of branched paths, may be efficiently applied.

Where each injector port member 120 is directly connected to the opposite ends of the associated branch tube 140, the amount of injected gas may vary, depending on respective positions of the nozzle holes 125 because the number of the nozzle holes 125 is large. In order to reduce such a problem, re-extension branch tubes 150 may be connected between each extension branch tube 140 and the injector port member 120 associated therewith, as shown in FIG. 5. Each re-extension branch tube 150 extends from an associated one of the opposite ends of the associated extension branch tube 140 to branch the gas path of the extension branch tube 140 into two paths. Also, each re-extension branch tube 150 is connected, at opposite ends thereof, to the associated injector port member 120. Thus, where each injector port member 120 is long such that a large number of nozzle holes 125 are widely distributed along the injector port member 120, it is desirable to use a multi-stage branch tube structure, as shown in FIG. 5, as compared to the case of FIG. 3.

Although the gas injector has been described as having an arrangement, in which the injector port members 120 are connected to the outlet ends of the branch tubes 130 branched from the main supply tube 110, respectively, it may have an arrangement, in which a single port member is connected to the outlet ends of all branch tubes 130. Such an arrangement may be implemented in the case of FIG. 3 by eliminating the branch tubes 130 such that the extension branch tubes 140 are directly connected to the main supply tube 110. In this case, a single port member may be connected to all branch tubes 130.

The above described gas injector according to the present invention may perform injection of gas over a wafer while rotating about the main supply tube 110. However, the gas injector need not rotate as long as a susceptor, on which a wafer is placed, rotates.

As apparent from the above description, in accordance with the present invention, gas is distributed through a plurality of branch tubes, and is then injected through a plurality of nozzle holes provided at injector port members. Accordingly, it is possible to achieve uniform gas injection, and thus, to achieve an improvement in process uniformity.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A gas injector for supplying gas into a reaction chamber, in which a substrate is placed, comprising:
a main supply tube extending through the reaction chamber such that an outlet end of the main supply tube is positioned in the interior of the reaction chamber, the main supply tube receiving gas supplied from an external gas supply source;
a plurality of branch tubes branched from the outlet end of the main supply tube; and
at least one injector port member connected to respective outlet ends of the branch tubes, the injector port member having a plurality of nozzle holes.

2. The gas injector according to claim 1, wherein the at least one injector port member comprises a single injector port member connected to the outlet ends of the branch tubes.

3. The gas injector according to claim 1, wherein the at least one injector port member comprises a plurality of injector port members respectively connected to the outlet ends of the branch tubes.

4. The gas injector according to claim 3, wherein the branch tubes have the same length.

5. The gas injector according to claim 3, wherein the branch tubes are radially branched from the outlet end of the main supply tube.

6. The gas injector according to claim 1, further comprising:
extension branch tubes extending from respective outlet ends of the branch tubes, each extension branch tube branching a gas path defined by an associated one of the branch tubes into at least two paths,
wherein each injector port member is connected to outlet ends of an associated one of the extension branch tubes.

7. The gas injector according to claim 6, further comprising:
re-extension branch tubes extending from respective outlet ends of each extension branch tube, each re-extension branch tube branching a gas path defined by the extension branch tube into at least two paths,
wherein the injector port member, which is associated with the extension branch tube, is connected to outlet ends of the re-extension branch tubes.

8. The gas injector according to claim 1, wherein each injector port member has a bar shape or a plate shape.

9. The gas injector according to claim 1, wherein the injector port members are arranged in parallel to the substrate.

10. The gas injector according to claim 1, wherein the main supply tube is rotatable about an axis thereof.
